(19) United States
(12) Patent Application Publication
(10) Pub. No.: US 2007/0181473 A1
(43) Pub. Date: Aug. 9, 2007

(54) Water desalination installation

(76) Inventors: Thomas Manth, Aachen (DE); Eli Oklejas, Monroe, MI (US); Michael Gabor, Kaarst (DE)

Correspondence Address: WILLIAM COLLARD;COLLARD & ROE, P.C., 1077 NORTHERN BOULEVARD, ROSLYN, NY, 11576, US

(21) Appl. No.: 10/587,009

(22) PCT Filed: May 23, 2003
(86) PCT No.: PCT/EP03/05390

§ 371 Date: Jul. 21, 2006

(30) Foreign Application Priority Data
Jan. 22, 2003 (EP) PCT/EP03/05390

(51) Int. Cl. B01D 63/00

(52) U.S. Cl. 210/137; 210/321.65; 210/637; 210/652

(57) ABSTRACT

The invention relates to a water desalination installation for the desalination of seawater according to the reverse osmosis method. This installation comprises at least one membrane module that is connected with a raw water feed line, via which raw water is supplied by means of a high-pressure pump; with a permeate line, via which the desalinated water is discharged; and with a concentrate line, via which concentrated salt water is discharged. For permitting the pressure to be adapted in the raw water feed line to the salt content and the temperature of the water to be desalinated, and for increasing at the same time the energy efficiency of such a water desalination installation, the invention proposes that provision is made for an energy recovery unit that comprises a motor-driven pressure booster pump arranged in the raw water feed line either before the high-pressure pump or between the high-pressure pump and them membrane module; and a turbine that is arranged in the concentrate line and mechanically coupled with the pressure booster pump.

The invention relates to a water desalination installation for the desalination of seawater according to the reverse osmosis process, having at least one membrane module that is connected with a raw water feed conduit, by way of which raw water is supplied by means of a high-pressure pump, and with a permeate conduit, by way of which the desalinated water is discharged, and with a concentrate conduit, by way of which concentrated salt water is discharged.

In known seawater desalination plants operating according to the reverse osmosis process, the seawater to be desalinated is subjected to a substance separation process by means of a semi-permeable membrane. Such a membrane is understood to be a selective membrane, which is permeable to a high degree to the water molecules, but only to a very low extent to the salt ions dissolved therein.

According to the usually employed conversion process, at least one membrane module is the center piece of the sea-water desalination plants operating according to the reverse osmosis process. Such a membrane module provides for the filtration a membrane surface area that is as large as possible. The seawater to be desalinated is admitted to this membrane module by way of a raw water conduit with the help of a high-pressure pump. The pressure to be raised by the high-pressure pump is determined by the osmotic pressure, on the one hand, which is primarily dependent upon the salt content of the water to be desalinated; on the temperature; as well on the desired amount of desalinated water to be produced. The desalinated water, which is referred to as the so-called permeate, is discharged from the membrane module by way of a permeate conduit. A concentrate conduit serves for discharging concentrated salt water.

The operating costs of water desalination plants operating according to the reverse osmosis principle are primarily determined by the energy to be applied. The important energy consumer is in this connection the drive of the high-pressure pump, by means of which the seawater to be desalinated is forced through the semi-permeable membranes of the membrane module. Energy saving measures are usually employed and are required especially in connection with reverse osmosis plants operating on the large technical scale, in order to keep the costs for the desalinated water as low as possible.

It is known according to the state of the art to make provision for a turbine in the concentrate line for the purpose of saving costs. It is possible by means of such a turbine to recover part of the energy applied. Use is made in this connection of the fact that the pressure difference between the raw water side and the concentrate side of the membrane module is comparatively low. The concentrate therefore contains considerable hydraulic energy, because it is at a pressure slightly lower than the feed pressure while the flow rate of the concentrate is typically 40 to 70 percent of the feed flow rate. For example, a reverse osmosis device is known from DE 299 07 813 U1, in which the pressure of the concentrated salt water discharged via the concentrate line is used for recovering energy. Provision is made in this connection for a volumetric pump installed in the concentrate line. This pump operates as a turbine and in this way reduces the pressure in the concentrate line in order to recover in this manner the excess energy. The recovered energy is used in the known installation for driving the high-pressure pump, so that overall, the amount of energy that has to be expended for driving the high-pressure pump is reduced.

Especially in large plants, where several 100 cubic meters of salt water are processed per hour, the known operational principle is afflicted with a number of drawbacks.

In reverse osmosis plants, it is always necessary to adapt the pressure that is generated by means of the high-pressure pump to the environmental conditions, which primarily are the temperature as well as the salt content of the seawater to be desalinated, so as to obtain the predetermined amount of production of desalinated water. The pressure can be adapted, for example by means of suitable throttling valves for regulating the feed stream of raw water. This, however, is connected with substantial energy losses because the high-pressure pump always has to generate the maximum pressure, and because part of the expended energy is converted into non-recoverable heat loss due to the throttling. It would be conceivable as an alternative to make provision for a high-pressure pump with variable capacity for adapting the pressure. However, multi-stage high-pressure centrifugal pumps are usually employed in large-scale installations that are driven by a three-phase motor, whereby the output of the three-phase motor is in the range of from several 100 kW's to several MW's. Controlling of the capacity and the pressure, i.e. the operating point of the installation, can be accomplished in connection with such a pump only by means of a suitable variable frequency drive, by means of which it is possible to vary the number of revolutions of the three-phase motor. In the specified output range, variable frequency drives are disadvantageously extremely expensive, susceptible to defects, and also maintenance-intensive because of the output semiconductors that have to be used. Furthermore, the variable frequency drives cause non-negligible losses of electrical energy. A further drawback is caused by the fact that the high-pressure pump is capable of operating with the maximum degree of efficiency only at a fixed number of revolutions. A variation of the number of revolutions leads to the fact that the high-pressure pump operates with a lower degree of efficiency, which in turn leads to high energy losses.

On the basis of the above considerations, the present invention is based on the problem of providing a water desalination device that can be employed on the large technical scale and permits adaptation of the operating point in the raw water feed line with maximum energy efficiency, i.e. with minimal specific energy expenditure based on the quantity of permeate produced.

Based on a water desalination installation of the type specified above, this problem is solved in that provision is made for an energy recovery unit comprising a motor-driven pressure booster pump arranged in the raw water feed line either before the high-pressure pump or between the high-pressure pump and the membrane module; and a first turbine arranged in the concentrate line and mechanically coupled with the pressure booster pump.

In the water desalination device as defined by the invention, the pressure in the raw water feed line is exclusively controlled by varying the capacity of the pressure booster pump. The high-pressure pump operates continually at a fixed number of revolutions and thus with the optimal degree of efficiency, so that high energy efficiency is assured in this area. According to the invention, the pressure booster pump, which only serves the purpose of varying the operating point with adaptation to the fluctuating environmental conditions, may be rated for a distinctly lower power requirement than the high-pressure pump. The operating point is adapted by controlling the output of the drive motor driving the pressure booster pump. This is possible with low expenditure because of the low power requirement of the pressure booster pump. The driving power required for the pressure booster pump is reduced further by the turbine which, according to the invention, is arranged in the concentrate line and mechanically coupled with the pressure booster pump, which additionally is to the benefit of the energy efficiency. The motor drive of the pressure booster pump needs to expend only the output corresponding with the difference between the power required for increasing the pressure in the raw water feed conduit, and the energy recovered by means of the turbine. According to the invention, the operating point in the raw water feed line can be adapted according to the invention without notable loss of energy.

The high-pressure pump of the water desalination installation as defined by the invention is usefully a multi-stage, first centrifugal pump, which is driven by a first three-phase motor at a constant speed. A plant for the desalination of seawater on a large technical scale designed accordingly offers benefits with respect to the design of the pumps to be employed. By virtue of the fact that the high pressure is generated in the raw water feed line by two independent pumps, namely the high-pressure pump and the pressure booster pump, additional degrees of freedom are obtained that can be used for optimizing the desalination plant. Owing to the fact that the first centrifugal pump is operated with a fixed rotational speed, it is possible to completely dispense with an expensive and maintenance-intensive variable frequency drive in this location. This results in a substantial reduction of the operating and investment costs.

For adapting the operating point in the raw water feed line, it is usefully possible to make provision instead for a variable frequency drive, by means of which the number of revolutions of a second three-phase motor is controlled, and which drives the pressure booster pump. In sea-water desalination plants operating on a large technical scale, the first three-phase motor of the high-pressure pump has typically an output of several 100 kW's up to several MW's, whereas the second three-phase motor driving the pressure booster pump has a distinctly lower output than the first three-phase motor, namely in the range of only a few kW's up to a few hundred kW's. Suitable variable frequency drives for the low output range are commercially available in the market at low cost in the form of prefabricated components. In the event of defects, such small-dimensioned variable frequency drives can be replaced at low cost, so that it is even possible to keep a suitable variable frequency drive in stock as a spare part. In the low output range of the second three-phase motor, electrical losses caused by the frequency conversion are hardly of any consequence.

A useful further development of the water desalination installation as defined by the invention is obtained in that the pressure booster pump is a second centrifugal pump, whereby this second centrifugal pump and the first turbine are arranged on a common driving shaft. Such a mechanical coupling between the pressure booster pump and the first turbine can be realized in a simple manner. The energy recovered by means of the turbine can be particularly effectively converted into energy for driving the pressure booster pump.

The efficiency of the water desalination installation as defined by the invention can be raised further in that provision is made for a branch in the concentrate line located between the membrane module and the energy recovery unit. Concentrated salt water can be supplied via this branch line to a second turbine that is mechanically coupled with the high-pressure pump. In the water desalination installation as defined by the invention, operating conditions may occur under which substantially more energy can be recovered from the concentrate line than is actually required for driving the pressure booster pump. It is useful in such a case to drive the second turbine via the branch in the concentrate line in order to recover in this way additional energy for driving the high-pressure pump. If the high-pressure pump according to the invention is designed in the form of a multi-stage centrifugal pump, it will be useful also in this case to mechanically couple the high-pressure pump and the second turbine with each other via a common driving shaft. For optimally exploiting the recoverable energy for driving the pressure booster pump, on the one hand, and the high-pressure pump on the other, it is useful to make provision for a throttling valve that is installed between the branch and the second turbine.

Because of the high degree of efficiency, the recovery of energy is particularly effective if the first and/or the second turbine(s) are Pelton turbines. It is particularly advantageous in this connection that the pressure can be relieved to zero via the Pelton turbines. Alternatively, the first and/or the second turbine(s) may be Francis turbines with adjustable guide vanes.

Furthermore, on the basis of a water desalination plant of the type specified above, the problem on which the invention is based can be resolved in that provision is made for an energy recovery unit comprising a pressure booster pump arranged in the raw water feed line either before the high-pressure pump or between the high-pressure pump and the membrane module; and a first turbine arranged in the concentrate line and mechanically coupled with the pressure booster pump; whereby provision is made in the concentrate line between the membrane module and the energy recovery unit for a branch, via which concentrated salt water can be supplied to a second turbine mechanically coupled with the high-pressure pump; and whereby provision is made between the branch and the second turbine for a throttling valve.

In the water desalination installation designed as specified above, the motor drive for driving the pressure booster pump is dispensed with. The operating point is adapted through variation of the stream of concentrate supplied to the first turbine by varying by means of the throttling valve the amount of concentrate supplied to the second turbine via the branch line.

By omitting the motor drive of the pressure booster pump, it is possible to further reduce the investment costs. The benefits of the water desalination installation as defined by the invention as described above remain preserved. The high-pressure pump operates with a constant speed, so that an optimal degree of efficiency is assured at this point. According to the invention, the stream of concentrate is divided by means of the branch line and the throttling valve in order to optimally use the recovered energy both for driving the pressure booster pump, and the high-pressure pump.

It is particularly advantageous if a Pelton turbine is employed for each of the first and/or the second turbines for achieving a maximal degree of efficiency in the energy recovery process.

The operational principle on which the invention is based, which is the adaptation of the operating point by means of a pressure booster pump, such a pump being driven by means of a turbine that is arranged in the concentrate line, can be applied in a multi-stage water desalination installation as well. Such a water desalination installation comprises a first membrane module that is connected with a raw water feed line, via which raw water is supplied by means of a high-pressure pump; with a permeate line, via which desalinated water is discharged; and with a first concentrate line, via which concentrated salt water is discharged from the first membrane module; as well as a second membrane module in which concentrated salt water is supplied via the first concentrate line, whereby the second membrane module is connected with a second permeate line, via which desalinated water is discharged, and connected also with a second concentrate line, via which concentrated salt water is discharged.

The problem to be solved in this connection is to again adapt the operating point in the first concentrate line—via which the concentrate to be desalinated is supplied to the second membrane module—with maximum efficiency.

Based on a water desalination installation of the type specified above, this problem is resolved in that provision is made for a pressure booster pump that is arranged in the first concentrate line between the first and the second membrane modules, and for a first turbine that is arranged in the second concentrate line and mechanically coupled with the pressure booster pump, whereby provision is made for a branch line between the second membrane module and the first turbine in the second concentrate line. Via this branch line, concentrated salt water can be supplied to a turbine that is mechanically coupled with the high-pressure pump, and provision is made for a throttling valve that is provided between the branch line and the second turbine.

In the multi-stage water desalination installation as defined by the invention, it is possible to adapt the operating point in the first concentrate line by varying the stream of concentrate supplied to the second turbine by means of a throttling valve. In addition, it is possible to make provision for a motor drive for driving the pressure booster pump. As described above, this motor drive has a distinctly lower power level as compared to the drive of the high-pressure pump. It is therefore possible to employ as the motor drive for the pressure booster pump a three-phase motor whose number of revolutions can be controlled by means of a variable frequency drive. The first and/or the second turbines are advantageously Pelton turbines, so that a maximum degree of efficiency is achieved in the energy recovery process. Alternatively, the first and/or the second turbine(s) may be Francis turbines with adjustable guide vanes.

So as to be able to adapt the operating point in the raw water feed line to the environmental conditions with maximum energy efficiency, it is possible in the multi-stage water desalination installation as defined by the invention to make provision for an energy recovery unit—of the type described above—in the raw water feed line as well, i.e. between the high-pressure pump and the first membrane module. Such an energy recovery unit is comprised of an additional pressure booster pump, which is arranged in the raw water feed line and may be motor-driven, if need be, and an additional turbine that is arranged in the first or the second concentrate line and mechanically coupled with said pressure booster pump. This turbine, too, usefully should be a Pelton turbine for obtaining a maximum degree of efficiency.

On the basis of a water desalination installation for the desalination of seawater according to the reverse osmosis method, comprising a first membrane module that is connected with a raw water feed line, via which raw water is supplied by means of a high-pressure pump; a permeate line, via which the desalinated water is discharged; as well as a first concentrate line, via which concentrated salt water is discharged, the problem on which the invention is based can also be resolved in that a turbine arranged in the first concentrate line is mechanically coupled with the high-pressure pump, wherein concentrated salt water is supplied to the turbine via at least one second concentrate line from at least one second membrane module. The high-pressure pump can practically be driven by a three-phase motor, the number of revolutions of which can be controlled by means of a variable frequency drive. For obtaining a maximum degree of efficiency, the turbine may be a Pelton turbine.

This variant of the invention is particularly well-suited for the upgrading of existing water desalination plants by one or more further membrane modules. In this way, the energy stored in the concentrate of the already existing membrane modules is used for driving the high-pressure pump of the additional membrane module by supplying this concentrate to the turbine, which is applied for driving the high-pressure pump of the upgraded membrane module. In accordance with the functional principle on which the present invention is based, the motor drive of the high-pressure pump needs to expend only the output corresponding with the difference between the power required for building up the pressure in the raw water feed conduit of the first membrane module, and the energy recovered from the concentrate by means of the turbine. Therein, the first and the second and—if necessary—the further membrane modules are operating completely independently as far as the respective pressure values in the raw water feed lines and in the concentrate lines are concerned, such that an accomodation of variations in membrane performance is possible without problems.

Exemplified embodiments of the invention are explained in the following with the help of the drawings, in which

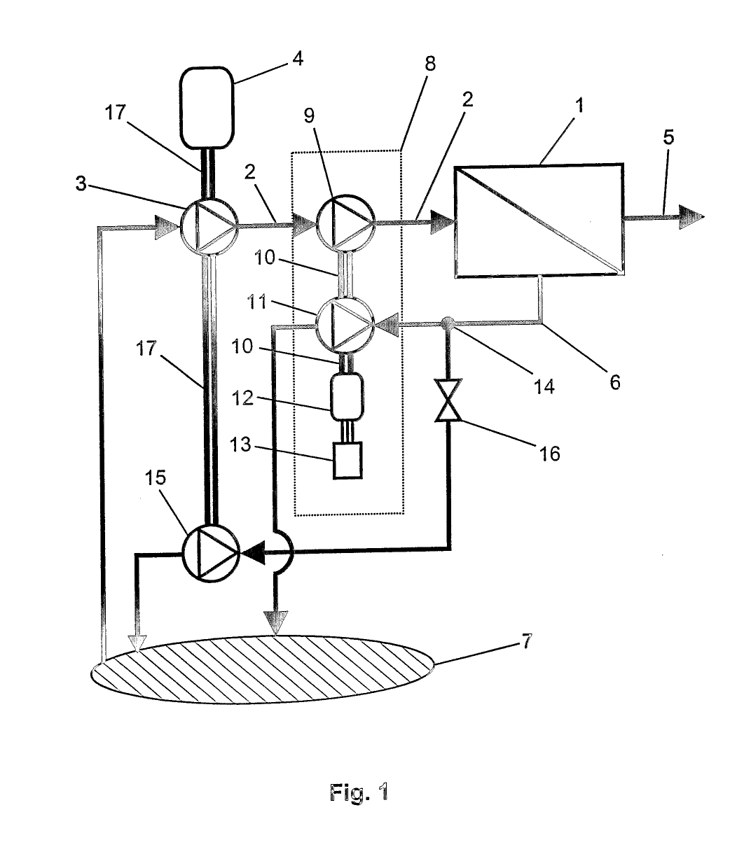

FIG. 1 is a block diagram of a water desalination installation as defined by the invention.

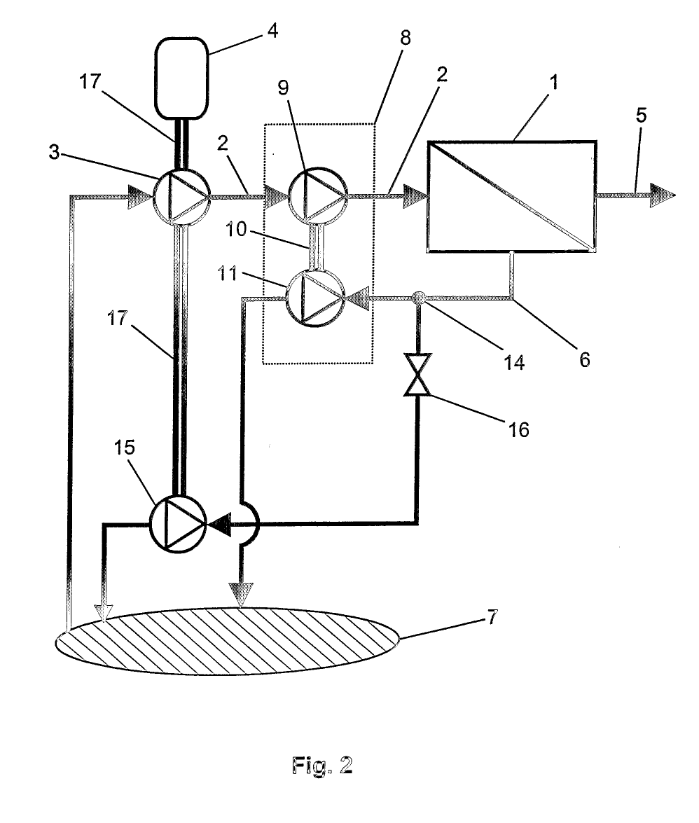

FIG. 2 shows a water desalination installation as defined by the invention without a motor drive for the pressure booster pump.

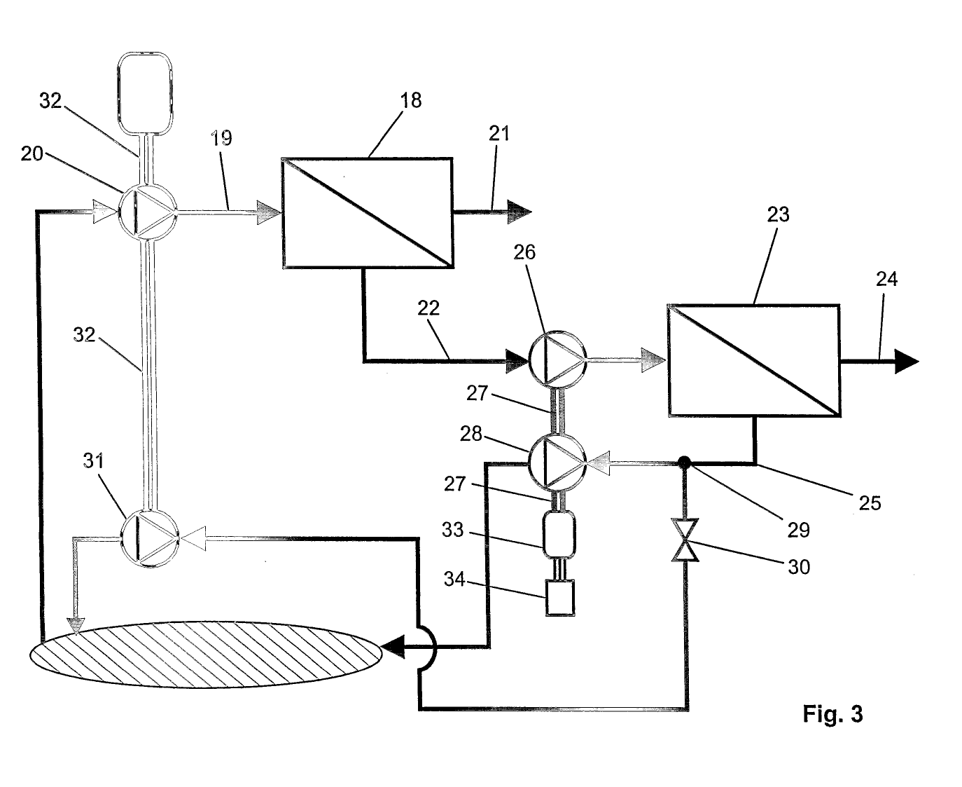

FIG. 3 is a block diagram of a multi-stage water desalination installation as defined by the invention; and

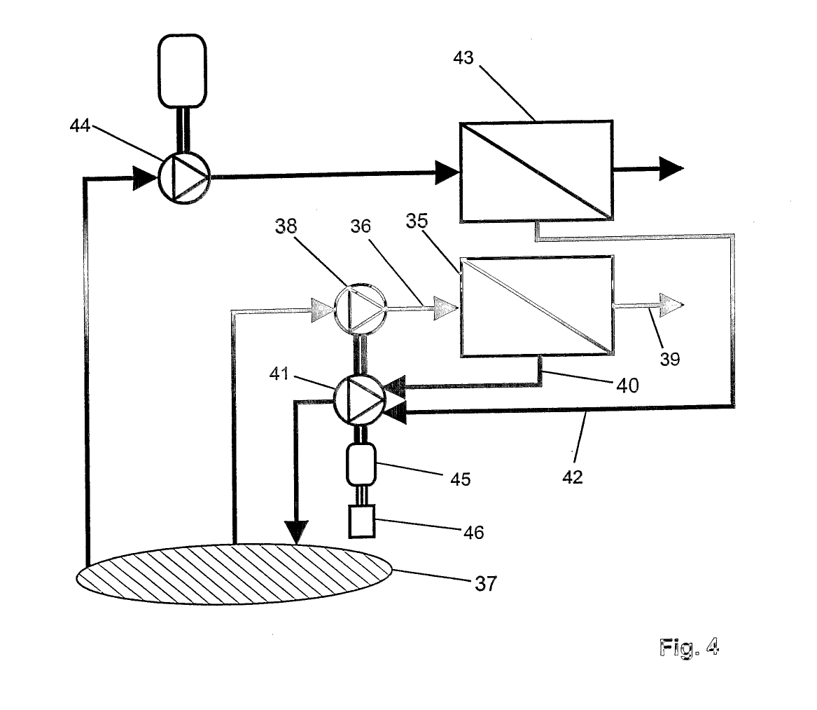

FIG. 4 is a block diagram of a further variant of a water desalination plant in accordance with the invention.

FIG. 1 shows a block diagram of a water desalination installation as defined by the invention. Located in the center of the installation is a membrane module 1, which contains the membranes for the filtration of the water. The membrane module 1 is supplied with the salt-containing raw water under high pressure via a raw water feed line 2. This purpose is served by a high-pressure pump 3, which is a multi-stage centrifugal pump that is driven by a three-phase motor 4 at a fixed number of revolutions. The desalinated water is discharged from the membrane module 1 via a permeate line 5. Furthermore, provision is made for a concentrate line 6, by way of which concentrated salt water is discharged. The high-pressure pump 3 taps the water to be desalinated from a water reservoir 7. This water may be, for example, seawater.

FIG. 1 shows an energy recovery unit which, as a whole, is denoted by reference numeral 8. The energy recovery unit comprises a pressure booster pump 9. This pump is arranged in the raw water feed line 2 between the high-pressure pump 3 and the membrane module 1. Said pressure booster pump may be a centrifugal pump. The rotor of this pump is connected via a common drive shaft 10 with a turbine 11 that is arranged in the concentrate line 6. In addition to the turbine 11, a three-phase motor 12 serves for driving the pressure booster pump 9. The number of revolutions of said motor can be controlled by means of a variable frequency drive 13. The turbine 11 is a Pelton turbine that reduces the pressure in the concentrate line 6 to zero, so that the concentrate delivered by the turbine 11 can be directly admitted into the reservoir 7.

In the water desalination installation shown in FIG. 1, provision is made between the membrane module 1 and the energy recovery unit 8 for a branch line 14, so that concentrated salt water can be tapped from the concentrate line 6, when needed, and directly supplied to an additional turbine 15. The quantity of the concentrated salt water discharged via the branch line 14 can be controlled via a throttling valve 16. Similar to the purpose served by the turbine 11, the turbine 15 serves for recovering energy, whereby the turbine 15 is coupled with the rotor of the high-pressure pump 3 via a common drive shaft 17. The turbine 15 is a Pelton-type turbine with a high degree of efficiency as well. The water delivered by the turbine 15 is supplied to the reservoir 7 as well.

The water desalination installation as defined by the invention and shown in FIG. 2 corresponds with the installation shown in FIG. 1, with the difference that the pressure booster pump 9 of the energy recovery unit 8 can operate without a motor drive. In the exemplified embodiment according to FIG. 2, the operating point in the raw water feed line 2 is exclusively adapted by varying the stream of concentrate supplied to the turbine 5 via the branch line 14. The throttling valve 16 serves for such a variation.

In the multi-stage water desalination installation shown in FIG. 3, provision is made for a first membrane module 18 that is connected with a raw water feed line 19 via which raw water is supplied by means of a high-pressure pump 20. Furthermore, the first membrane module 18 is connected with a first permeate line 21, via which desalinated water is discharged, and with a first concentrate line 22, via which concentrated salt water is discharged from the first membrane module 18. Concentrated salt water is supplied to a second membrane module 23 via the first concentrate line 22, whereby the second membrane module 22 discharges desalinated water by means of a second permeate line 24. In addition, a second concentrate line 25 serves for discharging concentrated salt water from the second membrane module 23.

According to the invention, a pressure booster pump 26 is arranged in the first concentrate line 22 between the first membrane module 18 and the second membrane module 23. A first turbine 28, which is arranged in the second concentrate line 25, is mechanically coupled with the pressure booster pump 26 via a common drive shaft 27. In addition, provision is made in the second concentrate line 25 for a branch line 29, as well as for a throttling valve 30. Concentrated salt water can be supplied to a second turbine 31 via said branch and said valve. The high-pressure pump 20 is driven by means of the second turbine 31 via a common drive shaft 32. As shown in FIG. 3, for adapting the operating point in the first concentrate line 22, provision can be additionally made for a three-phase motor 33 for driving the pressure booster pump 26. The operating point is then controlled by means of a variable frequency drive 34.

FIG. 4 shows a water desalination installation according to a variant of the invention. It comprises a first membrane module 35 that is connected with a raw water feed line 36. Via the raw water feed line 36 raw water from a reservoir 37 is supplied to the first membrane module 35 by means of a high-pressure pump 38. The desalinated water is discharged from the first membrane module 35 via a permeate line 39. Concentrated salt water is discharged from the first membrane module 35 via a first concentrate line 40. A turbine 41 arranged in the first concentrate line 40 is mechanically coupled with the high-pressure pump 38. Additionally, concentrated salt water is supplied to the turbine 41 via a second concentrate line 42 from a second membrane module 43. The second membrane module 43 is supplied with raw water by a second high-pressure pump 44 from the reservoir 37. For the adaptation of the operating point in the raw water feed line 36, provision is made for a three-phase motor 45 for driving the high-pressure pump 38. The adaptation of the operating point is made by means of a variable frequency drive 46.

1. A water desalination installation for the desalination of seawater according to the reverse osmosis method, comprising at least one membrane module (1) that is connected with a raw water feed line (2), via which raw water is supplied by means of a high-pressure pump (3); a permeate line (5), via which the desalinated water is discharged; as well as a concentrate line (6), via which concentrated salt water is discharged, an energy recovery unit (8) comprising a motor-driven pressure booster pump (9) arranged in the raw water feed line (2) either before the high-pressure pump (3) or between the high-pressure pump (3) and the membrane module (1); and a first turbine (11) arranged in the concentrate line (6) and mechanically coupled with the pressure booster pump (9).

2. The water desalination installation according to claim 1, wherein the high-pressure pump (3) is a multi-stage, first centrifugal pump driven at a constant number of revolutions by a first three-phase motor (4).

3. The water desalination installation according to claim 1, wherein the pressure booster pump (9) is driven by a second three-phase motor (12), the number of revolutions of which can be controlled by means of a variable frequency drive (13).

4. The water desalination installation according to claim 2, wherein the first three-phase motor (4) has an output ranging from a. few hundred kW's to a few KW's, whereas the second three-phase motor (12) has a lower output than the first three--phase motor (4), ranging from a few kW's to a few hundred kW's.

5. The water desalination installation according to claim 1, wherein the pressure booster pump (9) is a second centrifugal pump, whereby the second centrifugal pump and the first turbine (11) are arranged on a common drive shaft (10).

6. The water desalination installation according to claim 1, wherein provision is made for a branch (14) in the concentrate line (6) between the membrane module (1) and the energy recovery unit (8), via which branch concentrated salt water can be supplied to a second turbine (15), the latter being mechanically coupled with the high-pressure pump (3).

7. The water desalination installation according to claim 6, wherein provision is made between the branch (14) and the second turbine (15) for a throttling valve (16).

8. The water desalination installation according to claim 1, wherein the first and/or the second turbine(s) are Pelton turbines.

9. The water desalination installation according to claim 1, wherein the first and/or the second turbines are Francis turbines with adjustable guide vanes.

10. A water desalination installation for desalinating seawater according to the reverse osmosis method, comprising at least one membrane module (1) connected with a raw water feed line (2), via which raw water is supplied by means of a high-pressure pump (3); a permeate line (5), via which the desalinated water is discharged; and a concentrate line (6), via which concentrated salt water is discharged, an energy recovery unit (8) comprising a pressure booster pump (9) arranged in the raw water feed line (2) either before the high-pressure pump (3) or between the high-pressure pump (3) and the membrane module (1); and a first turbine (11) arranged in the concentrate line (6) and mechanically coupled with the pressure booster pump (9); whereby provision is made in the concentrate line (6) between the membrane module (1) and the energy recovery unit (8) for a branch (14), via which concentrated salt water can be supplied to a second turbine (15) mechanically coupled with the high-pressure pump (3); and whereby provision is made between the branch (14) and the second turbine (15) for a throttling valve (16).

11. The water desalination installation according to claim 10, wherein the first and/or the second turbines are Pelton turbines.

12. A water desalination installation for the desalination of seawater according to the reverse osmosis method, comprising a first membrane module (18) connected with a raw water feed line (19), via which raw water is supplied by means of a high-pressure pump (20); a first permeate line (21), via which desalinated water is discharged; a first concentrate line (22), via which concentrated salt water is discharged from the first membrane module (18); and a second membrane module (23), which is supplied with concentrated, salt water by way of the first concentrate line (22), whereby the second membrane module (23) is connected with a second permeate line (24), via which desalinated water is discharged, and with a second concentrate line (25), via which concentrated salt water is discharged, a pressure booster pump (26) being arranged in the first concentrate line (22) between the first and the second membrane modules, and by a. first turbine (28), said turbine being arranged in the second concentrate line (25) and mechanically coupled with the pressure booster pump (26); whereby provision is made in the second concentrate line (25) between the second membrane module (23) and the first turbine (28) for a branch (29), via which concentrated salt water can be supplied to a second turbine (31), the latter being mechanically coupled with the high-pressure pump (20); and whereby provision is made between the branch (29) and the second turbine (31) for a throttling valve (30).

13. The water desalination installation according to claim 12, wherein the first and/or the second turbines are Pelton turbines.

14. The water desalination installation according to claim 12, wherein the pressure booster pump (26) is motor-driven.

15. The water desalination installation according to claim 14, wherein the pressure booster pump (26) is driven by a three-phase motor (33), the number of revolutions of which is controllable by means of a variable frequency drive (34).

16. A water desalination installation- for the desalination of seawater according to the reverse osmosis method, comprising a first membrane module (35) that is connected with a raw water feed line (36), via which raw water is supplied by means of a high-pressure pump (38); a permeate line (39), via which the desalinated water is discharged; as well as a first concentrate line (40), via which concentrated salt water is discharged, wherein a turbine (41) arranged in the first concentrate line (40) is mechanically coupled with the high-pressure pump (38), wherein concentrated salt water is supplied to the turbine (41) via at least one second concentrate line (42) from at least one second membrane module (43).

17. The water desalination installation according to claim 16, wherein the high-pressure pump (38) is driven by a three-phase motor (45), the number of revolutions of which can be controlled by means of a variable frequency drive (46).

18. The water desalination installation according to claim 16, wherein the turbine (41) is a Pelton turbine.

19. Energy recovery unit for a water desalination installation operating according to the reverse osmosis method, comprising a pressure booster pump (9) and a Pelton turbine (11), whereas the pressure booster pump (9) and the Pelton turbine (11) are arranged on a common drive shaft (10).

20. Energy recovery unit according to claim 19, comprising a three-phase motor (12) for driving the pressure booster pump (9), whereby the number of revolutions of the three-phase motor (12) can be controlled by means of a variable frequency drive (13).
